(19) United States
(12) Patent Application Publication
(10) Pub. No.: US 2007/0039422 A1
(43) Pub. Date: Feb. 22, 2007

(54) Spark plug sockets for engine headers

(76) Inventor: Scott J. Rogers, Riverside, CA (US)

Correspondence Address: JOHN S. CHRISTOPHER, 6033 WEST CENTURY BOULEVARD, SUITE #400, LOS ANGELES, CA, 90045-6416, US

(21) Appl. No.: 11/588,888

(22) Filed: Oct. 26, 2006

Related U.S. Application Data
(63) Continuation-in-part of application No. 10/462,175, filed on Jun. 16, 2003, now abandoned.

(51) Int. Cl. B25B 13/00

(52) U.S. Cl. 81/124.2

(57) ABSTRACT

A multi-piece tool system for use with access obstructed spark plugs in an internal combustion engine including a plurality of spark plug sockets each comprising a unitary construction and having a different length. Each socket includes an upper portion and a lower portion, the upper portion including an upper external hex surface for cooperating with a wrench for turning the spark plug in the engine. The lower portion is flared and includes a lower internal hex surface for capturing a corresponding external male hex surface formed on the spark plug. A center through bore passes between the upper portion and the lower portion for receiving a body of the spark plug. A vertical mill slot is formed in the lower internal hex surface for shortening the effective length of the socket for facilitating the installation onto the spark plug at an installation angle of ninety degrees.

This patent application is a continuation-in-part application under 37 C.F.R. Section 1.53(b)(2) of parent patent application having Ser. No. 10/462,175 filed 5 Jun. 16, 2003, now abandoned.

### BACKGROUND OF THE INVENTION

1. Technical Field

The present invention relates to mechanical tools. More specifically, the present invention relates to methods and apparatus for a multi-piece tool system comprising spark plug sockets of varying lengths each having a vertical mill slot for facilitating installation of the sockets onto access obstructed spark plugs at up to a ninety degree installation angle in an internal combustion engine.

2. Background Art

Automobiles fitted with internal combustion engines represent the primary source of transportation for many commuters. Manufacturers of internal combustion engines have advanced the designs of their engine products in recent years. Many of these designs now require sophisticated peripheral equipment to support the operation and control of modern motor cars. The peripheral equipment can be, for example, pollution control equipment, air conditioning compressors, cooling system hardware, fuel injection systems, on-board computer control systems, and the like. Consequently, automobile manufacturers who actually construct modern engine designs are forced to assemble the engine components in a very tight and compact manner. As a result, some components such as sparking plugs are not easily accessible. Thus, the periodic servicing of these sparking plugs becomes a more difficult task.

Most automobile engines that are assembled on an automobile manufacturers assembly line are equipped with an exhaust manifold where each engine exhaust port includes an exhaust pipe that feeds into the exhaust manifold. The exhaust side of the engine is a suitable example of compact engine design because the configuration of the exhaust manifold and other engine components often shroud or block the spark plugs on the exhaust side. Consequently, the engine component such as, for example, a single cast exhaust manifold or other peripheral component, is itself the obstruction that blocks access to the spark plugs. Furthermore, some engines are equipped with custom designed components that create further blockage in the engine compartment. An example of such a design component is an exhaust header. In a six-cylinder engine, six separate exhaust pipes or tubes exit the exhaust side of the engine with one exhaust pipe or tube connected to each of the exhaust ports at the outlet of each of the engine cylinders. All six of the exhaust pipes are routed to a “collector” to commonize the individual exhaust tubes. Consequently, the “collector” is a means to bring all the exhaust tubes together.

An advantage of employing an exhaust header in a customized engine is that use of an exhaust header provides greater exhaust flow to remove the spent exhaust gases which have not burnt. Thus, removing the unburned exhaust gases provides more volume within the engine cylinders to combust a new load or charge of combustible fuel injected into the engine block. This situation leads to improved engine performance and improved engine efficiency. Unfortunately, exhaust headers as well as exhaust manifolds tend to cause obstruction to at least one of the engine cylinders. Consequently, the servicing or changing out of the spark plug associated with the obstructed cylinder is a problem for the modern automobile mechanic.

As a result, there has been a long felt need in the art to quickly service sparking plugs on conventional internal combustion engines that suffer from space limitations and/or the use of performance exhaust systems. Presently, there is not an acceptable tool available for servicing sparking plugs in many instances, particularly engines fitted with exhaust headers. In general, it is a time consuming challenge to remove and install sparking plugs on engines fitted with an exhaust header. This is the case because often loosening or removing the exhaust header to gain access to the sparking plug is the only viable service method and may take from five minutes to an hour or more to accomplish. The conventional spark plug socket is a standard tool utilized by every automobile mechanic. The spark plug socket is specifically designed to service sparking plugs because of the specific size and shape of the sparking plug. The specific design of the conventional spark plug socket is also necessary because of the fragile nature of sparking plugs which include a ceramic or porcelain insulation body. If the insulating body which insulates the center electrode is fractured, then an spark leak to electrical ground will occur resulting in malfunction of the engine. This electrical problem can result in poor engine performance and engine damage if not repaired.

Each tool company that manufacturers and markets spark plug socket tools offer a variety of spark plug socket designs. Under normal unobstructed conditions, most of these spark plug designs function as intended. However, when an engine is fitted with a set of performance race car style exhaust headers, the conventional spark plug sockets will fail to perform the required tasks as intended. For example, in a conventional “V-8” eight cylinder engine design, a mechanic may successfully service seven of the eight sparking plugs with relative ease utilizing the conventional spark plug sockets. However, the eighth sparking plug may be obstructed by the presence of the engine exhaust header. Consequently, the only suitable option available in the prior art was to remove the exhaust header from the engine to gain clearance so that there was sufficient space to employ the conventional spark plug socket.

The problem associated with conventional spark plug sockets is as follows. Conventional spark plug sockets are designed to be inserted on the sparking plug along the same axis that passes through the centerline of the sparking plug. Thus, the centerline of the conventional spark plug socket is congruent with the centerline of the sparking plug being serviced. As a result, this requires that the conventional spark plug socket can only deviate a few mechanical degrees from the centerline of the sparking plug. If the conventional spark plug socket deviates too far, then the conventional spark plug socket will be misaligned from the centerline of the sparking plug and will not properly fit over the sparking plug. For this reason, if an exhaust header is installed on an engine and one of the exhaust tubes or pipes is an obstacle to the centerline of the axis of the sparking plug, then the conventional spark plug socket cannot be installed on the sparking plug. Furthermore, a conventional open-end or closed-end wrench cannot be used to tighten or loosen the sparking plug because the sparking plug is countersunk thus locating the external male hex surface formed on the sparking plug below the surface of the cylinder head. Thus, these conventional wrenches cannot access the external male hex surface to rotate the sparking plug.

Various spark plug and mechanical tools have been known in the past. For example, U.S. Pat. No. 2,570,779 to Dodge et al. on Oct. 9, 1951 teaches a Reversible Ratchet Wrench having a body member presenting at one end a handle portion by which the wrench is manipulated and at the other end a socket receiving head in which is mounted both a rotatable socket member and pawls by which the socket member can be turned in either direction. U.S. Pat. No. 5,009,343 to Pugatch on Apr. 23, 1991 teaches an Automotive Tool which has a head, a container and a flexible hose connection with the container. The container has a nozzle and a pump and the hose connects the nozzle of the container to the head. The head has a blade which extends longitudinally and is arced so that it may be positioned within the nipple of a plug wire terminal of an automobile spark plug so that it is between the inner wall of the nipple and the top cap of the spark plug. U.S. Pat. No. 5,074,172 to Fetter et al. on Dec. 24, 1991 teaches a Spark Plug Socket Wrench having a tubular body member with an interior hexagon socket end arranged to freely receive the hexagon end base of a spark plug. An elongated groove is provided in the hexagon socket end which receives a leaf spring secured at one of its ends and arranged to engage a portion of the hexagon base of a spark plug for releasably holding the spark plug in the wrench. The tubular body member has a square opening at its end opposite from the hexagon socket end arranged for engagement by a ratchet drive mechanism. U.S. Pat. No. 5,074,173 to Cearley on Dec. 24, 1991 teaches a Spark Plug Tool for installing a spark plug which utilizes a flexible shaft having a tubular housing on one end and a handle located on the other end of the flexible shaft. The tubular housing has internal polygonal sides formed in it for mating with the polygonal sides of a spark plug. A square hole formed in the upper end of the housing receives a conventional socket torque tool.

Additionally, U.S. Pat. No. 4,749,251 to Moulin on Jun. 7, 1988 teaches a Connector Locking System utilized with a fiber optic modular connector system which includes a receptacle connect 30 and a locking leaf spring 17 having a locking tang 17c mounted on the receptacle connector 30. The disclosed connector system further includes a connector installation and removal tubular wrench 50 which has an elongated housing 35 and an internally splined socket 39 for selectively meshing with and engaging the external splines of the plug connector coupling ring 23. U.S. Pat. No. 6,044,732 to Astle on Apr. 4, 2000 teaches a Plumbing Tool for tightening the drain assembly of a shower and includes a shaft having opposite proximal and distal ends and a tubular first bell reducer having open proximal and distal ends. The distal end of a second bell reducer has there around a plurality of spaced apart notches to define a plurality of spared apart teeth around the distal end of the second bell reducer. Finally, U.S. Patent Publication No. US 2004/0035260 to Adkison on Feb. 26, 2004 teaches a Tool With Engaging Portion Having Axial Opening And Radial Slot, the tool having a handle, shaft and an engaging portion with a first end and a second end where the first end is connected to the shaft. The engaging portion has a slot extending from the first end to the second end thereby defining an axial inner surface, the axial inner surface having a plurality of engaging surfaces.

Thus, there is a need in the art for a spark plug socket for engine headers comprising a multi-piece tool system including spark plug sockets each of unitary construction and varying lengths and having an upper external hex surface for turning the spark plug with a wrench, a lower internal hex surface for capturing the spark plug, a center through bore, and a vertical mill slot for facilitating installation of the sockets onto access obstructed spark plugs at up to a ninety degree installation angle in an internal combustion engine.

### DISCLOSURE OF THE INVENTION

Briefly, and in general terms, the present invention provides a new and improved spark plug socket for use with engine headers that is comprised of a multi-piece tool system including a plurality of spark plug sockets each of unitary construction having a different length and having an upper external hex surface for turning the spark plug with a wrench, a lower internal hex surface for capturing the spark plug, a center through bore for receiving the body of the spark plug, and a vertical mill slot for facilitating installation of the spark plug sockets onto access obstructed spark plugs at up to a ninety degree installation angle in an internal combustion engine.

In general, the multi-piece tool system is comprised of several spark plug sockets, each socket being a combination of a different dimension and a different length for use with different size spark plugs found in a variety of internal combustion engines. The multi-piece tool system typically is used with spark plugs whose access thereto is obstructed by an engine component such as, for example, an engine header. The unitary construction of the spark plug sockets comprises an upper portion and a lower portion separated by a reduced diameter mid-section. The upper external hex surface is formed on the upper portion just adjacent to an upper open terminal end. The upper external hex surface is intended to cooperate with an open-end or closed-end box wrench for turning the spark plug upon which the spark plug socket is mounted.

The lower portion of the spark plug socket is flared outwardly beginning at the reduced diameter mid-section and includes the lower internal hex surface which mates with and captures a corresponding external male hex surface formed on the external surface of the spark plug. Because of this connection, any movement of the spark plug socket is transferred to the spark plug. An internal abutment wall is formed within the lower internal hex surface for intercepting and stopping the external male hex surface formed on the spark plug. The spark plug socket also includes a center through bore passing between the upper portion and the lower portion for receiving the body of the spark plug. The spark plug sockets are primarily intended to be used to install and/or remove spark plugs whose access is obstructed by an engine component. Consequently, each spark plug socket includes a vertical mill slot formed in the lower internal hex surface of the lower portion.

The vertical mill slot is arch-shaped and borders on a lower open terminal end. The vertical mill slot functions to shorten the effective length of the spark plug socket for facilitating the installation of the spark plug socket onto the spark plug at an installation angle of up to and including ninety degrees. Because access to the spark plug is obstructed, a closed-end or box-end wrench or the mechanic's hand must be fished into the narrow spaces of the engine to reach the spark plug. The spark plug socket often must be positioned at an angle to be placed onto the body of the spark plug. In the most extreme position, the spark plug socket is positioned adjacent to the spark plug at an installation angle of ninety degrees, that is, the spark plug socket is at a right angle to the spark plug. A tip of the body of the spark plug is aligned with and extends through the vertical mill slot. Because the vertical mill slot extends to approximately the full length of the lower internal hex surface, the tip of the body of the spark plug is positioned immediately above the center through bore. Consequently, as the spark plug socket is rotated about its horizontal axis, the tip of the body of the spark plug enters the center through bore. The tip of the spark plug passes all the way through the spark plug socket until the external male hex surface formed on the spark plug is stopped by the internal abutment wall. The tip of the spark plug then extends out of the upper open terminal end 122 of the spark plug socket. The lower internal hex surface of the spark plug socket then mates with the external male hex surface formed on the spark plug. The upper external hex surface of the spark plug socket can now be rotated about its center axis with the closed-end or box-end wrench to either install or remove the spark plug with respect to the internal combustion engine. These steps associated with the installation of the spark plug socket onto the spark plug are reversed to accomplish removal of the spark plug socket.

In a preferred embodiment, the spark plug sockets for use with spark plugs whose access is obstructed by an engine header or other engine component in its most fundamental form comprises a multi-piece tool system for use with access obstructed spark plugs in an internal combustion engine including a plurality of spark plug sockets each comprising a unitary construction and having a different length. Each socket includes an upper portion and a lower portion, the upper portion including an upper external hex surface for cooperating with a wrench for turning the spark plug in the engine. The lower portion is flared and includes a lower internal hex surface for capturing a corresponding external male hex surface formed on the spark plug. A center through bore passes between the upper portion and the lower portion for receiving a body of the spark plug. A vertical mill slot is formed in the lower internal hex surface for shortening the effective length of the spark plug socket for facilitating the installation onto the spark plug at an installation angle of up to ninety degrees.

These and other objects and advantages of the present invention will become apparent from the following more detailed description, taken in conjunction with the accompanying drawings which illustrate the invention, by way of example.

### BRIEF DESCRIPTION OF THE DRAWINGS

FIG. 1 is a front right perspective view of a spark plug socket for an engine header of the preferred embodiment of the present invention showing a unitary construction having an upper portion including an upper external hex surface and a lower flared portion exhibiting a lower vertical mill slot.

FIG. 2 is a top plan view of the spark plug socket for an engine header of FIG. 1 showing an upper external hex surface, an upper open terminal end of the external hex surface, a center through bore, and a lower flared portion of the socket.

FIG. 3 is a bottom plan view of the spark plug socket for an engine header of FIG. 1 showing a lower internal hex surface, a lower open terminal end of the lower internal hex surface, a center through bore, an internal abutment wall, and the lower vertical mill slot.

FIG. 4 is a front elevation of the spark plug socket for an engine header of FIG. 1 showing the upper external hex surface, the lower vertical mill slot formed in the lower flared portion, and portions of the lower internal hex surface.

FIG. 5 is a rear elevation of the spark plug socket for an engine header of FIG. 1 showing the unitary construction including the upper external hex surface and the lower flared portion of the spark plug socket.

FIG. 6 is a left side elevation of the spark plug socket for an engine header of FIG. 1 showing the upper external hex surface, and the lower flared portion with the lower vertical mill slot positioned on the right side.

FIG. 7 is a right side elevation of the spark plug socket for an engine header of FIG. 1 showing the upper external hex surface, and the lower flared portion with the lower vertical mill slot positioned on the left side.

FIG. 8 is a cross-sectional view of the spark plug socket for an engine header of FIG. 1 taken along the line 8-8 of FIG. 4 showing the center through bore, the internal abutment wall, and the lower internal hex surface.

FIG. 9 is a perspective view of the spark plug socket of an engine header of FIG. 1 showing a spark plug exploded out of and aligned with the lower internal hex surface and the center through bore, the lower vertical mill slot and upper external hex surface being clearly visible.

FIG. 10 is a first of a sequence of perspective views of the installation of the spark plug socket onto a spark plug showing the spark plug socket positioned at a ninety degree installation angle and with the body of the spark plug aligned with the vertical mill slot.

FIG. 11 is a second of a sequence of perspective views of the installation of the spark plug socket onto the spark plug showing the spark plug socket positioned at less than a ninety degree installation angle and with the body of the spark plug continued to be aligned with the vertical mill slot.

FIG. 12 is a third of a sequence of perspective views of the installation of the spark plug socket onto the spark plug showing the spark plug socket fully positioned on the spark plug.

### DETAILED DESCRIPTION OF THE INVENTION

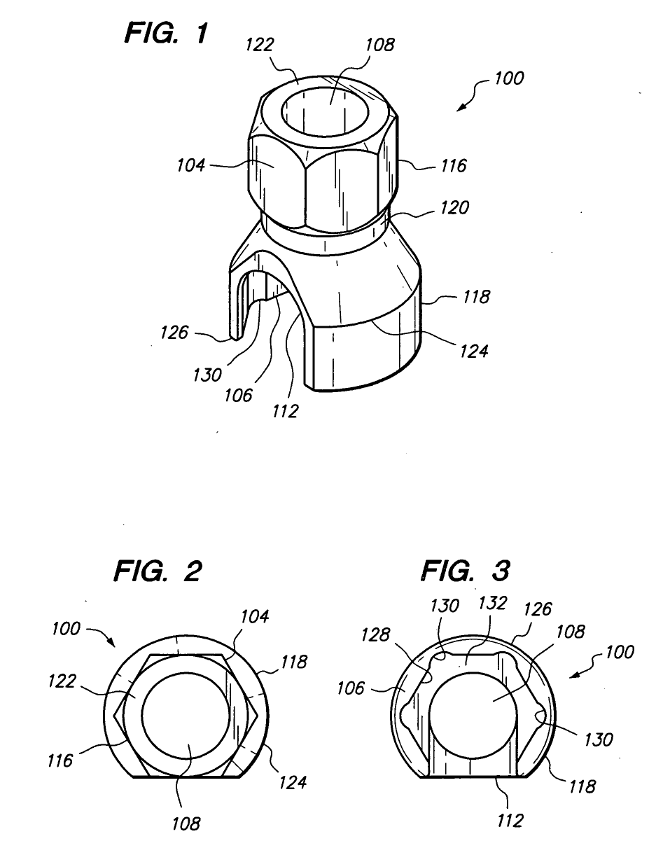

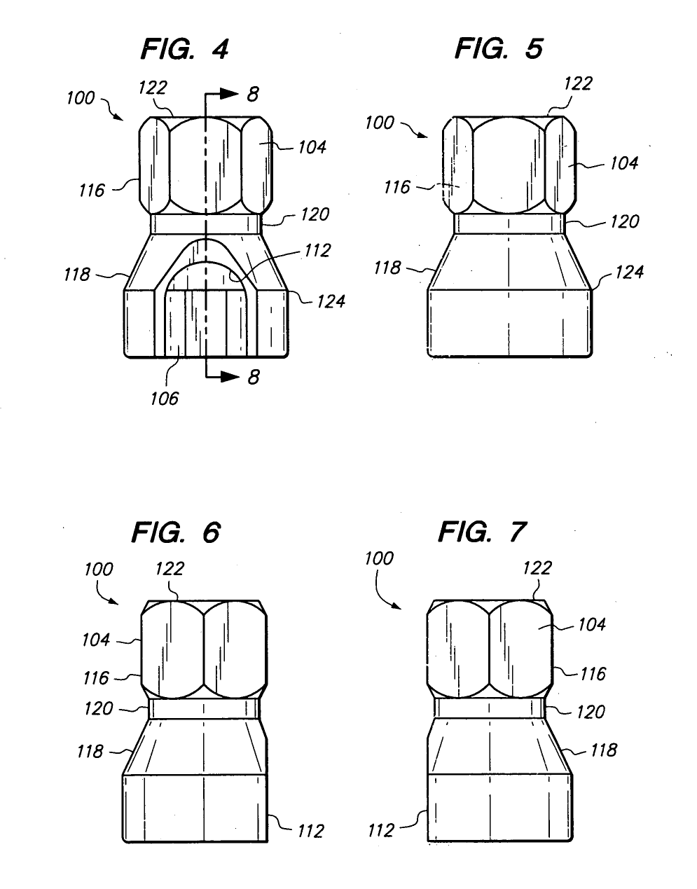

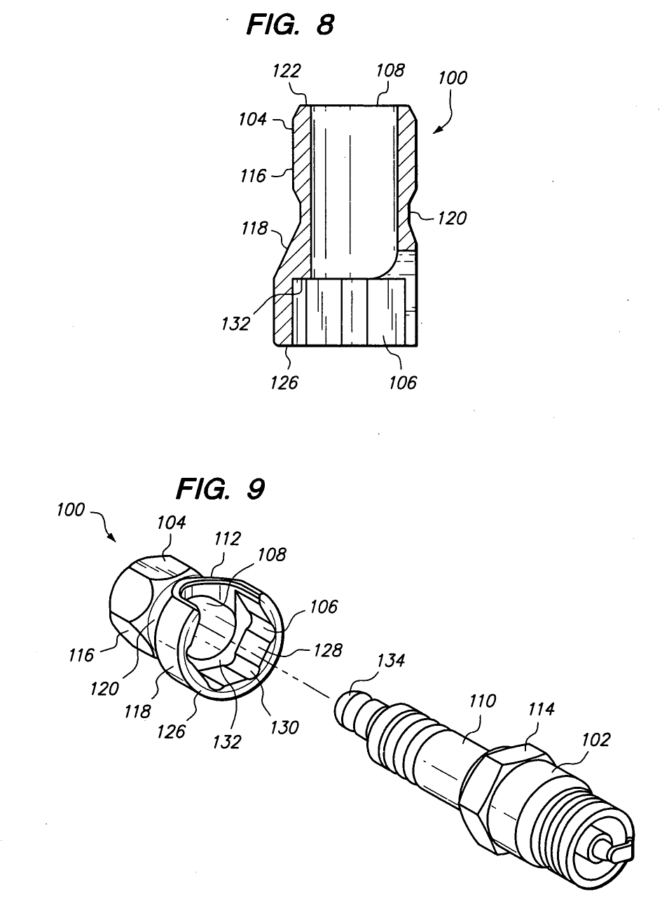

The present invention is a plurality of spark plug sockets 100 for use with an engine header (not shown) forming a multi-piece tool system for installing and removing spark plugs 102 whose access is obstructed by the engine header (not shown) or other engine component as shown in FIGS. 1-12. The multi-piece tool system includes the plurality of spark plug sockets 100 each exhibiting a unitary construction having a different length. Each spark plug socket 100 includes an upper external hex surface 104 for turning the spark plug 102 with a wrench (not shown), a lower internal hex surface 106 for capturing the spark plug 102, a center through bore 108 for receiving a body 110 of the spark plug 102, and a vertical mill slot 112 for facilitating installation of the spark plug sockets 100 onto the access obstructed spark plugs 102 at up to a ninety degree installation angle in an internal combustion engine (not shown).

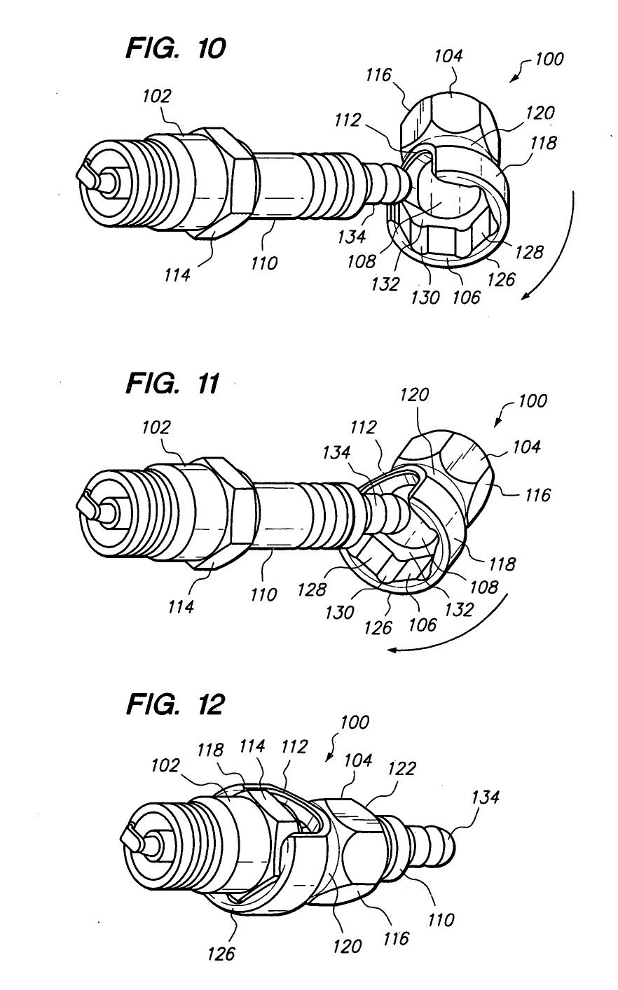

The present invention functions primarily to overcome the obstructed access problem associated with the spark plugs 102 caused by automobile engine components. Consequently, the primary objective of the present invention is to ensure that the obstructed spark plugs 102 can be installed and removed with relative ease compared to the problems experienced in the prior art. This primary objective is accomplished by designing the spark plug socket 100 to include the vertical mill slot 112 so that the spark plug socket 100 can be installed onto the obstructed spark plug 102 at up to and including a ninety degree installation angle as shown in FIGS. 10-12. Access to the relevant spark plug 102 is obstructed because of the density of engine components that exist in modern day automobiles. Therefore, there is little space available to install a conventional spark plug socket wrench (not shown) onto a spark plug 102 particularly when the conventional socket wrench must be installed within a few degrees of deviation of the centerline of the spark plug 102. The present invention is designed to include the lower internal hex surface 106 which receives and mates with an external male hex surface 114 formed on each spark plug 102 as shown in FIG. 10. Likewise, the center through bore 108 provides a passageway for the body 110 of the spark plug 102 to pass through as shown in FIG. 9. With these novel features, the spark plug socket 100 can be securely hand mounted (because of space limitations) onto the obstructed spark plug 102 utilizing the vertical mill slot 112. Likewise, the upper external hex surface 104 of the spark plug socket 100 can be rotated as required by use of a conventional hand wrench to either install or remove the spark plug 102.

A preferred embodiment of the spark plug socket 100 of the present invention will now be described in detail. The spark plug socket 100 is illustrated in FIGS. 1-8 while an exploded view and an installation sequence is shown in FIGS. 9 and 10-12, respectively. The spark plug sockets 100 comprise a plurality of sockets intended to be utilized on the exhaust side of the internal combustion engine to access spark plugs 102 which are obstructed by an exhaust manifold, exhaust header or other engine component. The plurality of spark plug sockets 100 form a multi-piece tool system where each socket is of a specific length dimension and a specific internal hex dimension. For example, each separation spark plug socket 100 can typically have an internal dimension of ⅝″ internal hex or an internal dimension of 13/16″ internal hex. Likewise, each spark plug socket 100 is available in length dimensions of short, medium and long. These dimensions yield six socket sizes including ⅝″ short, ⅝″ medium, and ⅝″ long, and 13/16″ short, 13/16″ medium and 13/16″ long. These different sized spark plug sockets 100 enable a mechanic to decide which socket 100 is most appropriate for the situation at hand. Furthermore, the varying lengths and cuts of the spark plug sockets 100 permit the servicing of spark plugs 102 for most engine and exhaust system combinations without having to remove the exhaust system as was required in the past.

The unitary construction of the spark plug sockets 100 comprises an upper portion 116 and a lower portion 118 separated by a reduced diameter mid-section 120 as shown in FIG. 1. The upper portion 116 includes the upper external hex surface 104 which terminates in an upper open terminal end 122. The upper external hex surface 104 is a six-sided configuration that is intended to cooperate with an open-end or closed-end box wrench for turning the spark plug socket 100. Since the spark plug socket 100 is mounted on the spark plug 102, the spark plug 102 will also rotate. It is noted that the spark plug socket 100 is physically rotated utilizing the box wrench in the minimal space available under the obstructed conditions. Separating the upper portion 116 and the lower portion 118 is the reduced diameter mid-section 120 as is clearly shown in FIGS. 1 and 4-7. The reduced diameter mid-section 120 enables the lower portion 118 of the spark plug socket 100 to be flared outwardly as is best shown in FIGS. 1 and 4-5. The flared portion is reduced to a vertical drop of zero degrees at an interface line 124 in the lower portion 118 as is shown best in FIGS. 1 and 5. This design assists in the formation of the lower internal hex surface 106 which is positioned within the lower portion 118 as is clearly shown in FIGS. 1, 4, 9 and 10. Located at the bottom of the lower internal hex surface 106 is a lower open terminal end 126 shown best in FIGS. 3, 9 and 11.

The lower internal hex surface 106 is actually comprised of five surfaces 128. Only five surfaces 128 are included in the lower internal hex surface 106 because of the existence of the lower vertical mill slot 112 as can be seen in FIG. 3. By cutting the lower internal hex surface 106 of the lower portion 118 to include the lower vertical mill slot 112, one of the six surfaces 128 of the lower internal hex surface 106 is eliminated. Each of the five surfaces 128 of the lower internal hex surface 106 is separated by a groove-like separation 130 as is best shown in FIGS. 3 and 9. The lower internal hex surface 106 mates with and captures the corresponding external male hex surface 114 formed on the external surface of the spark plug 102 as shown in FIGS. 9-12. Because of this connection, any movement of the spark plug socket 100 is transferred to the spark plug 102. An internal abutment wall 132 is formed within the lower internal hex surface 106 at the interface line 124 for intercepting and stopping the external male hex surface 114 formed on the spark plug 102 as is clearly shown in FIGS. 3 and 8-10. The spark plug socket 100 also includes the center through bore 108 passing between the upper portion 116 and the lower portion 118 for receiving the body 110 of the spark plug 102. The center through bore 108 is clearly shown in FIGS. 2 and 9 and operates in conjunction with the internal abutment wall 132 to receive the spark plug 102 and to limit the travel of the spark plug 102 through the spark plug socket 100.

The spark plug socket 100 is primarily intended to be used to install and/or remove spark plugs 102 whose access is obstructed by an engine component.

Consequently, each spark plug socket 100 includes a lower vertical mill slot 112 formed in the lower internal hex surface 106 of the lower portion 118. The vertical mill slot 112 is arch-shaped and borders on the lower open terminal end 126. The vertical mill slot 112 functions to shorten the effective length of the spark plug socket 100 for facilitating the installation of the spark plug socket 100 onto the spark plug 102 at an installation angle of up to and including ninety degrees. Because access to the spark plug 102 is obstructed, a closed-end or box-end wrench or the mechanic's hand must be fished into the narrow spaces of the engine to reach the spark plug 102. The spark plug socket 100 often must be positioned at an angle to be placed onto the body 110 of the spark plug 102. In the most extreme position, the spark plug socket 100 is positioned adjacent to the spark plug 102 at an installation angle of ninety degrees, that is, the spark plug socket 100 is at a right angle to the spark plug 102 as is shown in FIG. 10. A tip 134 of the body 110 of the spark plug 102 is aligned with and extends through the vertical mill slot 112. Because the vertical mill slot 112 extends the full length of the lower internal hex surface 106, the tip 134 of the body 110 of the spark plug 102 is positioned immediately above the center through bore 108 as shown in FIG. 10. Consequently, as the spark plug socket 100 is rotated about its horizontal axis, the tip 134 of the body 110 of the spark plug 102 enters the center through bore 108. The tip 134 of the spark plug 102 passes all the way through the spark plug socket 100 until the external male hex surface 114 formed on the spark plug 102 is stopped by the internal abutment wall 132. The tip 134 of the spark plug 102 then extends out of the upper open terminal end 122. The lower internal hex surface 106 of the spark plug socket 100 then mates with the external male hex surface 114 formed on the spark plug 102. The upper external hex surface 104 of the spark plug socket 100 can now be rotated about its center axis with the closed-end or box-end wrench to either install or remove the spark plug 102 with respect to the internal combustion engine. These steps associated with the installation of the spark plug socket 100 onto the spark plug 102 are reversed to accomplish removal of the spark plug socket 100.

Manufacture of the Invention:

The following is a general description of the current process of fabricating the spark plug sockets for engine headers 100. The process begins by utilizing one of either of two preferred materials which include (1) type 4340 steel aircraft alloy or (2) type 15-5 stainless steel aircraft alloy. However, it should be understood that any suitable material can be utilized. Both of these preferred materials are derived from solid round stock material. The first step of the fabrication process is to part and turn the material according to the design specifications using industry standard machining processes and equipment to obtain the correct length and correct outer diameter.

The next step in the process is to bore the dual center inside diameters to proper design specifications, and then to cut the upper external hex surface 104, once again using industry standard machining processes and equipment. The next step in the procedure is to cut the lower internal hex surface 106 to the proper design specifications. This step in the procedure can be accomplished by either utilizing the process of broaching or by utilizing electronic disintegration equipment (E.D.M.), once again using industry standard machining processes and equipment.

At this stage in the process, the unfinished spark plug socket 100 will need to be heat-treated to strengthen the material to the appropriate level. The range of from 180,000-to-200,000 pounds per square inch (psi) tensile strength is a suitable level for the two materials recited above. The actual heat-treatment method utilized is determined by the exact type of structural material employed. The final step in the process when employing the 15-5 stainless steel aircraft alloy material is to mill the vertical slot 112 in the lower internal hex surface 106 utilizing industry standard machining processes and equipment. The machining of the vertical mill slot 112 must be completed after the heat-treating process to ensure that the design tolerance of the spark plug socket 100 will be maintained. In conclusion, a quick polish and deburring procedure will provide a nice external finish to the spark plug socket 100.

When utilizing the 4340 steel aircraft alloy material, after the steps of machining the vertical slot 112 and the polishing and deburring procedure, an additional required step in the process includes exposing the spark plug socket 100 to nitrides to inhibit rust. This step in the process, of course, utilizes an industry standard nitrating method. The process of fabricating the spark plug socket 100 is now complete and the spark plug socket 100 is ready for use.

Use of Invention:

The following describes the procedure that should be followed for removal of a spark plug 102 using the spark plug socket 100 for engine headers. The mechanic will ensure that the area of the internal combustion engine to be serviced is cooled down so as to permit safe access about the engine components. Further, the appropriate heat protection should be provided if necessary. The ignition wire connected to the spark plug 102 is then removed so that the spark plug 102 to be serviced is exposed. The mechanic then makes a determination as to the best route to follow in order to access the spark plug 102. This will ensure that the mechanic can reach the spark plug 102 with the spark plug socket 100 and further enable the use of either an open-end or close-end wrench. The chosen access route will determine which size spark plug socket 100 is selected for use. The differing lengths and sizes in which the spark plug sockets 100 are available in combination with the selected wrench permits engaging the upper external hex surface 104 through the engine header tubes where there is sufficient space. A ratchet tool or air tool is not required. The spark plug sockets 100 are designed to be used with an open-end or closed-end wrench, although the longer sized spark plug socket 100 is fabricated with a square-drive to enable it to be used as a conventional spark plug socket employing a hand operated ratchet. Under some conditions, a suitable access point might be directly adjacent to the cylinder head requiring use of the short spark plug socket 100. Under other conditions, the access point might be at the approximate mid-point of the spark plug 102 requiring use of the medium length spark plug socket 100. Finally, the access point might be at the tip 134 of the spark plug 102 where the spark plug boot (not shown) is attached. Under these conditions, the long spark plug socket 100 would be required.

Once the correct length spark plug socket 100 is determined, it should be positioned onto the upper external hex surface 104 of the spark plug 102 to be serviced. The design of the present invention enables the vertical mill slot 112 formed in the lower internal hex surface 106 to be positioned onto the tip 134 of the spark plug 102 at up to and including an installation angle of ninety degrees. Thus, the vertical mill slot 112 can be perpendicular to the tip 134 of the spark plug 102 as is shown in FIG. 10. The spark plug socket 100 would then be rotated about its horizontal axis as shown in FIG. 11 until the center line of the spark plug 102 and the center line of the spark plug socket 100 are parallel as shown in FIG. 12. This feature directed to the use of the vertical mill slot 112 is one of the inventive features of the present invention. The vertical mill slot 112 formed on the spark plug socket 100 shortens the effective length of the socket 100. Consequently, a 2″ socket 100 having a 1″ vertical mill slot 112 provides the advantage of seemingly working with a 1″ socket 100. This design provides greater access to the spark plug 102 than does a full body length socket design. Notwithstanding the vertical mill slot 112 formed in the lower internal hex surface 106, the torque load for the spark plug socket 100 of the present invention remains above 100 ft. lbs. using the ⅝″ model design. The normal torque range for similar tools is between 15-22 ft. lbs. Thus, the present invention provides an average of a 5:1 safety loading which exceeds the current design ratio of 4:1.

The spark plug socket 100 is now positioned onto the spark plug 102 until the internal abutment wall 132 engages the external male hex surface 114 formed on the spark plug 102. Slight twisting of the spark plug socket 100 may be required to mesh with the external male hex surface 114. A ⅝″ open-end or closed-end wrench is then fished through the exhaust header tubing where possible to gain access to the upper external hex surface 104 of the socket 100. The available access may be from the top side or the bottom side of the engine. The wrench will be used to rotate the spark plug 102 counter-clockwise. Once the spark plug is initially loosened, it might be turned out and removed by hand taking as little time as five-ten seconds or as long as one-two minutes depending on the situation. Spark plug 102 removal is now compete without having to loosen or remove the entire exhaust header or other engine component.

Installation of a spark plug 102 is just as simple using the present invention. Initially the spark plug 102 is checked to determine if it is adjusted with the proper gap between the electrodes. Next, slide the spark plug socket 100 onto the spark plug 102 to be installed. Position the spark plug 102 and the spark plug socket 100 mounted thereon at the respective mounting hole on the internal combustion engine. Next, start the installation of the spark plug 102 by hand by rotating the spark plug socket 100 in the clockwise direction as far as possible. If the spark plug 102 is not seated, use either the open-end or closed-end wrench to start the spark plug 102 installation. Once the spark plug 102 is seated, tighten the spark plug 102 an additional 1/16-to-⅛ turn. Then, slide the spark plug socket 100 off of the spark plug 102 by rotating and sliding the vertical mill slot 112 over the spark plug 102 as necessary. Finally, re-install the boot end of the ignition wire onto the tip 134 of the spark plug 102. Installation of the spark plug 102 is now complete.

In a preferred embodiment of the present invention, the spark plug sockets 100 are used with spark plugs 102 whose access is obstructed by an engine header or other engine component. In its most fundamental form, the spark plug sockets 100 comprise a multi-piece tool system for use with access obstructed spark plugs 102 in an internal combustion engine and includes the plurality of spark plug sockets 100 each comprising a unitary construction and having a different length. Each socket 100 includes the upper portion 116 and the lower portion 118, the upper portion 116 including the upper external hex surface 104 for cooperating with a wrench for turning the spark plug 102 in the engine. The lower portion 118 is flared and includes the lower internal hex surface 106 for capturing the corresponding external male hex surface 114 formed on the spark plug 102. The center through bore 108 passes between the upper portion 116 and the lower portion 118 for receiving the body 110 of the spark plug 102. The vertical mill slot 112 is formed in the lower internal hex surface 106 for shortening the effective length of the spark plug socket 100 for facilitating the installation onto the spark plug 102 at an installation angle of up to and including ninety degrees.

Advantages:

The present invention provides novel advantages over other spark plug tools known in the prior art. The main advantages of the inventive spark plug sockets 100 for engine headers of the preferred embodiment are that: (1) the vertical mill slot 112 formed in the lower internal hex surface 106 allows the spark plug socket 100 to be installed starting from an installation angle of up to and including ninety degrees; (2) the vertical mill slot 112 enables the effective length of the spark plug socket 100 to be reduced even further than by shortening the physical length alone; (3) the long upper external hex surface 104 of each spark plug socket 100 allows for an extreme range of access for either the open-end or closed-end wrench; (4) the long upper external hex surface 104 formed on each spark plug socket 100 allows for a greater deflected grip angle; (5) the through bore 108 of the short and medium sized sockets 100 allow the spark plug 102 to extend from the end of the body 110 to allow a reduction in physical length which enable the sockets 100 to perform where conventional sockets cannot; (6) the precise through bore 108 centers the spark plug socket 100 to the spark plug 102 for avoiding damage to the ceramic insulator of the spark plug 102; (7) the multi-piece tool system of the present invention enables obstructed spark plugs 102 to be removed from internal combustion engines without the need to remove the engine exhaust headers to obtain access; (8) the spark plug sockets 100 can be designed to operate with any sized spark plug 102 by altering any of the dimensions to conform to the size of new spark plugs 102; and (9) on spark plug sockets 100 of 2″ or longer, an internal ⅜″ square hole is formed on the same side as the upper external hex surface 104 and on the same centerline thereof to facilitate the attachment of a common ⅜″ drive socket.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility.

It is therefore intended by the appended claims to cover any and all such modifications, applications and embodiments within the scope of the present invention.

Accordingly,

What is claimed is:

1. A spark plug socket for use with access obstructed spark plugs in an internal combustion engine comprising:
an upper portion and a lower portion having a unitary construction, said upper portion including an upper external hex surface for cooperating with a wrench for turning a spark plug whose access is obstructed in an internal combustion engine;
said lower portion including a lower internal hex surface for capturing a corresponding external male hex surface formed on said spark plug;
a center through bore passing between said upper portion and said lower portion for receiving a body of said spark plug; and
a vertical mill slot formed in said lower internal hex surface for shortening the effective length of said lower portion for facilitating the installation of said lower portion onto said spark plug at an installation angle of ninety degrees in said internal combustion engine.

2. The spark plug socket of claim 1 wherein said upper portion further includes an upper open end terminal.

3. The spark plug socket of claim 1 wherein said lower portion further includes a lower open end terminal.

4. A spark plug socket for use with access obstructed spark plugs in an internal combustion engine comprising:
an upper portion and a lower portion having a unitary construction, said upper portion including an upper external hex surface for cooperating with a wrench for turning a spark plug whose access is obstructed in an internal combustion engine;
said lower portion including a lower internal hex surface for capturing a corresponding external male hex surface formed on said spark plug;
a center through bore passing between said upper portion and said lower portion for receiving a body of said spark plug;
an internal abutment wall formed in said lower internal hex surface for stopping said external male hex surface formed on said spark plug; and
a vertical mill slot formed in said lower internal hex surface for shortening the effective length of said lower portion for facilitating the installation of said lower portion onto said spark plug at an installation angle of ninety degrees in said internal combustion engine.

5. A multi-piece tool system for use with access obstructed spark plugs in an internal combustion engine comprising:
a plurality of spark plug sockets for use with an access obstructed spark plug, each spark plug socket comprising a unitary construction and having a different length and including:
an upper portion and a lower portion, said upper portion including an upper external hex surface for cooperating with a wrench for turning said spark plug in an internal combustion engine;
said lower portion being flared and including a lower internal hex surface for capturing a corresponding external male hex surface formed on said spark plug;
a center through bore passing between said upper portion and said lower portion for receiving a body of said spark plug; and
a vertical mill slot formed in said lower internal hex surface for shortening the effective length of said spark plug socket for facilitating the installation of said spark plug socket onto said spark plug at an installation angle of ninety degrees in said internal combustion engine.

6. The spark plug socket of claim 5 wherein said upper portion further includes an upper open end terminal.

7. The spark plug socket of claim 5 wherein said lower portion further includes a lower open end terminal.

8. The spark plug socket of claim 5 further including an internal abutment wall formed in said lower internal hex surface for stopping said external male hex surface formed on said spark plug.
